(19) United States
(12) Patent Application Publication
(10) Pub. No.: US 2026/0219733 A1
(43) Pub. Date: Jul. 30, 2026

(54) MULTIPLATFORM COMMUNICATION AND CONTROL SYSTEM BASED ON HAPTIC FEEDBACK

(71) Applicant: Control Bionics Limited, Cremorne (AU)

(72) Inventor: James E. Schorey, Milford, OH (US)

(73) Assignee: Control Bionics Limited, Cremorne (AU)

(21) Appl. No.: 19/148,179

(22) PCT Filed: Jan. 12, 2024
(86) PCT No.: PCT/US24/11356

§ 371 Date: Jul. 15, 2025

Related U.S. Application Data
(60) Provisional application No. 63/480,241, filed on Jan. 17, 2023.

(51) Int. Cl. G06F 3/01

(52) U.S. Cl. CPC G06F 3/016; G06F 3/015

(57) ABSTRACT

A multiplatform communication and control system and method is disclosed. The system comprises one or more switches configured to be activated by a user. Each switch comprises user input devices to detect an input signal. The system further comprises a wearable user interface device comprising at least one haptic transducer, and a controller communicatively coupled to the switches and the wearable device. The transducer provides haptic stimulation to the wearable device. The controller detects at least one input signal and determines one or more output signals for the input signal. The controller assigns the first option to a first haptic signal and the second option to a second haptic signal. The controller provides the option as a haptic signal to the user. The controller is further configured to detect a volitional user input corresponding to the option selected by the user and communicates the option selected.

### CROSS-REFERENCE TO RELATED APPLICATIONS

The present application for patent claims priority to U.S. Provisional Application No. 63/480,241 entitled “MULTIPLATFORM COMMUNICATION AND CONTROL SYSTEM BASED ON HAPTIC FEEDBACK” filed Jan. 17, 2023, which is hereby expressly incorporated by reference herein in its entirety for all purposes.

### BACKGROUND

### 1. Technical Field

The present disclosure generally relates to a multiplatform communication and control system comprising a haptic-based user interface.

### 2. Description of the Related Art

An augmentative and alternative communication device (AACD) typically provides two methods of access: (i) direct select, which gives users a cursor or mouse pointer that can be positioned by means of a mouse, an eye tracker, or some similar device; and (ii) switch scanning, which provides the user a selection by an automatic or a user-induced method of advancing through all of the current choices. Selecting and activating a button or hotspot serves to initiate some assigned action (e.g., to speak a phrase or to switch a toy on or off). The choices are presented to the user by a display device, or as an audio option.

However, the display device may not be available with the user on all occasions. For example, the user may misplace the display device, or may not remember to carry the display device while visiting places. The audio options are also not always effective in outdoor environments. For example, entertainment venues are one of the noisy and crowded places where the audio option is not effective. Further, the device providing audio options can be heard not only by the user of the device, but also by other audiences at entertainment venues. Thus, audio option is a least preferred option by the user.

Therefore, there is a need for a system that addresses the above discussed drawbacks. Further, there is a need for a system comprising a user interface that enables the user to seamlessly interact with the system.

### BRIEF SUMMARY OF THE INVENTION

In one aspect, the present disclosure provides systems, methods, and apparatuses (hereinafter the “system”) that include monitoring a signal from a set of sensors placed on a user.

In another aspect, the present disclosure provides a system that includes a powerful new category of multiplatform communication and control system (MCACS) provided with haptic controls for enabling a user to communicate using an output of at least one prompt and at least one volitional input. Delivering the at least one prompt includes at least one of delivering the at least one prompt via a personal computing device; delivering the at least one prompt via a wearable item; delivering the at least one prompt via a prompting system attached to or mounted in or on an instrument, implement, article of equipment, or article of clothing; or delivering the at least one prompt via two or more of a display, a light, a speaker, a vibrator, an electrical stimulator, and an olfactory stimulus source.

In another aspect, the system includes a prompting system configured to deliver the at least one prompt for prompting the subject to perform at least one task. In various aspects, the prompting system is adapted to deliver an audio-visual prompt, a tactile prompt, a haptic prompt, or an electrical stimulus (which can produce various sensory effects, depending upon where the stimulus is applied). The prompting system may include, for example, a visible signal source adapted to deliver a visible prompt, e.g. a display or light. In other aspects, the prompting system includes a sound source, for example a speaker. In an aspect, the prompting system includes at least one electrical stimulator, mechanical stimulator (e.g. a vibrator or force-applying element), or olfactory stimulus source. In other aspects, the prompting system includes an ultrasonic stimulator or various other stimulators adapted to produce sensory or other consciously detectable effects in the subject, e.g., a thermal stimulator or electromagnetic stimulator. In an aspect, the prompting system includes two or more of a display, light, speaker, vibrator, force-applying element, mechanical stimulator, electrical stimulator, ultrasonic stimulator, olfactory stimulus source, or other sensory stimulator as described herein.

In an aspect, the MCACS includes at least one user interface device for at least one of providing an output to the subject and receiving an input from the subject. In an aspect, at least one user interface device includes one or more components of personal computing device. The user interface device includes one or more output device, such as an LED or other light emitting element, an alphanumeric display, a graphical display, or other screen, audio output, tactile display, actuator or haptic output device, or input devices, e.g., a touchscreens, keyboard, mouse, button, dial, or voice command input.

In another aspect, the MCACS may include other components as known to those skilled in the art, e.g., one or more power supply, I/O structure, clock, timer, data bus, etc. An I/O structure permits communication with various types of user interface devices, which may include one or more input devices such as a keyboard, button, switch, computer mouse, or touchscreen or one or more output devices such as screen, actuator, haptic output device, sound source, alphanumeric display, and communication with various types of remote device, which may have control/processing capability conferred by control/processing circuitry.

In yet another aspect, the present invention discloses a multiplatform communication and control system. The system comprises one or more switches configured to be activated by a user. Each switch comprises a set of user input devices to detect an input signal. The system further comprises a wearable user interface device comprising at least one haptic transducer, and a controller communicatively coupled to the switches and the wearable device. The transducer is configured to provide haptic stimulation or vibration to the user of the wearable device. The controller is configured to detect at least one input signal and determine one or more output signals for the input signal. The controller assigns the first option to a first haptic signal and the second option to a second haptic signal. The controller provides various options as to the haptic signal or signals sent to the user. The controller is further configured to detect a volitional user input corresponding to the option selected by the user and communicate the option selected by the user.

In yet another aspect, the haptic output device is operable to provide haptic feedback in response to an activating command or signal. The haptic output device may provide multiple tactile or haptic feedbacks wherein one tactile feedback is used for choice selections, while another tactile feedback is used for input confirmation. Input confirmation is by haptic feedback to inform a user about a selected input. The haptic output device, for example, can be implemented by various techniques including vibration, vertical displacement, lateral displacement, push/pull technique, air/fluid pockets, local deformation of materials, resonant mechanical elements, piezoelectric materials, micro-electro-mechanical systems (“MEMS”) elements, thermal fluid pockets, MEMS pumps, variable porosity membranes, laminar flow modulation, or the like.

In yet another aspect, active or ambient device sensor data may be used to modify the haptic feedback based on any number of factors relating to a user's environment or activity. For example, an accelerometer device sensor signal may indicate that a user is engaging in physical activity such as walking or running, so the pattern and duration of the haptic feedback should be modified to be more noticeable to the user. In another example, a microphone sensor signal may indicate that a user is in a noisy environment, so the amplitude or intensity of the haptic feedback should be increased. Sensor data may also include virtual sensor data which is represented by information or signals that are created from processing data such as still images, video or sound. For example, a video game that has a virtual racing car may dynamically change a haptic effect based on the car velocity, how close the car is to the camera viewing angle, the size of the car, and so on.

In one aspect, the system includes a sensing system for detecting performance of an activity by the subject. In various aspects, the sensing system is adapted to detect performance of a mental activity by the subject, performance of a physical activity by the subject, or performance of two or more related physical or mental activities by the subject. In other aspects, the sensing system includes sensors adapted for sensing parameters not directly related to the activity performed by the subject, but pertinent to control of stimulation or other aspects of operation of the system. The sensing system includes one or more sensors, including, for example, at least one of a neural sensor (for example, an EEG sensor, an ENG sensor, an EOG sensor), an EMG sensor, a motion sensor, a pressure sensor, a force sensor, an accelerometer, an inclinometer, a camera, a haptic device, a scanner, an optical sensor, a microphone, a temperature sensor, physiological sensor, a location sensor, any eye tracking sensor, an attention sensor, or an environmental sensor. In various aspects, sensing system includes one or more of an implantable sensor, a wearable sensor, a sensor carried by the subject, a sensor in or on an instrument, implement, or article of equipment carried by the subject, or a remote sensor.

In yet another aspect, the present invention discloses a method for providing multiplatform communication and control. At one step, the controller of the system is configured to detect at least one input signal. The input signal includes at least one of a user input signal and an external event occurrence signal. At another step, the controller is configured to determine one or more output options for the input signal. The options include a first option and a second option. At yet another step, the controller is configured to assign the first option to a first haptic signal and the second option to a second haptic signal. In another embodiment, the user is enabled to pre-configure haptic signal to the options. At yet another step, the controller is configured to provide a first haptic simulation corresponding to the first haptic signal and a second haptic simulation corresponding to the second haptic signal to the user. The haptic stimulation or signal is provided using the wearable device. At yet another step, the controller is configured to detect a volitional user input corresponding to at least one option selected by the user and communicating the option selected by the user.

In yet another aspect, the input signal includes at least one of contextual input data, user input data, and external device/third-party input data. The output signal includes at least one of audio, visual, device or actuator signal. In another aspect, the output signal is directed to one or more displays, one or more speakers, one or more haptic output devices, or one or more controllable electronic devices. In yet another aspect, the user input devices include one or more electromyography (EMG) assistive technology devices.

In some interface devices, kinesthetic feedback (such as active and resistive force feedback) and/or tactile feedback (such as vibration, texture, and heat) is also provided to the user, more generally known collectively as “haptic feedback” or “haptic effects”. Haptic feedback can provide cues that enhance and simplify the user interface. Specifically, vibration effects, or vibrotactile haptic effects, may be useful in providing cues to users of electronic devices to alert the user to specific events, or provide realistic feedback to create greater sensory immersion within a simulated or virtual environment.

In order to generate vibration effects, many devices utilize some type of actuator or haptic output device. Known haptic output devices used for this purpose include an electromagnetic actuator such as an Eccentric Rotating Mass (“ERM”) in which an eccentric mass is moved by a motor, a Linear Resonant Actuator (“LRA”) in which a mass attached to a spring is driven back and forth, or a “smart material” such as piezoelectric, electro-active polymers or shape memory alloys. Haptic output devices also broadly include non-mechanical or non-vibratory devices such as those that use electrostatic friction (ESF), ultrasonic surface friction (USF), or those that induce acoustic radiation pressure with an ultrasonic haptic transducer, or those that use a haptic substrate and a flexible or deformable surface, or those that provide projected haptic output such as a puff of air using an air jet, and so on. Additional haptic output device includes at least one of a controllable compression garment, an electrical stimulation device, a force applying device, a vibrotactile device, or a haptic device.

Dynamic haptic effects are haptic or vibrotactile effects displayed on haptic devices to represent a change in state of a given input signal. The input signal can be a signal captured by sensors such as position, acceleration, pressure, orientation, or proximity, or signals captured by other devices and sent to the haptic device to influence the generation of the haptic effect. A dynamic effect signal can be any type of signal, but does not necessarily have to be complex. For example, a dynamic effect signal may be a simple sine wave that has some property such as phase, frequency, or amplitude that is changing over time or reacting in real time according to a mapping schema which maps an input parameter onto a changing property of the effect signal. An input parameter may be any type of input capable of being provided by a device, and typically may be any type of signal such as a device sensor signal. A device sensor signal may be generated by any means.

In yet another aspect, the input signal comprises a device sensor input. In another aspect, the input signal comprises an input received from a remotely coupled device. In another aspect, the device sensor input comprises an ambient input selected from the group consisting of accelerometer, gyroscope, microphone, photometer, thermometer or altimeter. In another aspect, the device sensor input comprises a bio monitor input selected from the group consisting of skin or body temperature, blood pressure (BP), heart rate monitor (HRM), Electrocardiogram (ECG), Electroencephalogram (EEG), Electromyography (EMG), Electrooculography (EOG), Electropalatography (EPG) or Galvanic Skin Response (GSR).

In one aspect, the one or more electromyography (EMG) assistive technology devices (e.g., a NeuroNode® device, Control Bionics, Inc., Milford, Ohio), according to one or more embodiments, is used to provide an input signal to a controller, which can then send an output signal as haptic signal to the user via the transducer.

In another aspect, the present disclosure illustrates various techniques and configurations to enable a series of dynamic workflows for the selection and presentation of content from an information system relevant to activities of a human user. The dynamic workflows used with the user input device as described herein enable the integration of user interfaces and user communication platforms to achieve relevant and timely communication among users and others and related actions. The dynamic workflows described herein further may be integrated with social networks and portable communication mediums to provide additional availability and delivery of content to users in a variety of settings.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a multiplatform communication and control system (MCACS), according to an embodiment of the present invention.

FIG. 2 exemplarily illustrates a user wearing an input device, according to an embodiment of the present invention.

FIG. 3 exemplarily illustrates a perspective view of the input device of FIG. 2.

FIG. 4 exemplarily illustrates an environment of a computing device of the system, according to an embodiment of the present invention.

FIG. 5 exemplarily illustrates an environment of a multiplatform communication and control system (MCACS), according to another embodiment of the present invention.

FIG. 6 exemplarily illustrates a perspective view of a magnetic connector, according to an embodiment of the present invention.

FIG. 7 exemplarily illustrates a flowchart of a method providing multiplatform communication and control, according to an embodiment of the present invention.

FIG. 8 exemplarily illustrates a screenshot of user interface, which allows the user to configure haptic feedback, according to an embodiment of the present invention.

FIG. 9 exemplarily illustrates a screenshot of switch design to configure a haptic signal for an input signal, according to an embodiment of the present invention.

FIG. 10 exemplarily illustrates a screenshot of the system showing one or more output options and corresponding haptic signal for each output option, according to an embodiment of the present invention.

FIG. 11 exemplarily illustrates a screenshot of the system showing a list of output options and corresponding haptic signal for each output option, according to an embodiment of the present invention.

FIG. 12 exemplarily illustrates a screenshot of the system showing one or more output options and corresponding haptic signal for each output option, according to another embodiment of the present invention.

FIG. 13 exemplarily illustrates a screenshot of the system showing one or more output options and corresponding optional haptic signal field for each output option, according to yet another embodiment of the present invention.

FIG. 14 exemplarily illustrates a screenshot of the system showing one or more output options and corresponding optional haptic signal field for each output option, according to yet another embodiment of the present invention.

FIG. 15 exemplarily illustrates a screenshot of the system to configure a haptic signal to activate one or more controls, according to an embodiment of the present invention.

FIG. 16 exemplarily illustrates a screenshot of the system to configure a haptic signal to activate one or more controls, according to an embodiment of the present invention.

FIG. 17 exemplarily illustrates a screenshot of the system to configure a haptic signal to activate one or more controls, according to an embodiment of the present invention.

### DETAILED DESCRIPTION

### Definitions

Embodiments described below in context of the user input devices are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

The term “activation” as used herein refers to activation of one or more of the components using an input signal from an input device, user input device, or other component capable of initiating a signal.

As utilized herein, the terms “component,” “computer component,” “system,” “client” and the like are intended to refer to a computer-related entity, either hardware, software (e.g., in execution), firmware, or a combination thereof.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks. Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

The term “controller” as used herein indicates a method, process, or computer component adapted to affect a user device (i.e., the system to be controlled or effected).

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

As used herein, the term “electrode” means an operable connection to a muscle or nerve that allows an electrical potential to be recorded or applied. An electrode can be further described by its location, i.e., internal, external or percutaneous; electrical or other recording characteristics, i.e., unipolar, bipolar, magnetic or optical; and with respect to internal electrodes by its placement, i.e., intramuscular, epimysial, or nerve.

The term “electronic device” is used to designate any devices that can have a microprocessor and that can be communicated with. A microprocessor can include one or more processors, memory and programmable input/output peripherals. A controller can include one or more microprocessors and/or memory with instructions that can help control or communicate with electronic devices.

As used herein, when the term “function” is used to describe a relationship between one variable or parameter and a second variable or parameter, the relationship so described is not considered to be an exclusive relationship unless expressly stated, rather the other variables or parameters that are not mentioned or described but that are known to those of ordinary skill in the art may also have a functional relationship to the second variable or parameter. By way of example, if x is described as a function of y the statement is not intended to limit x's value to only being described by y unless expressly stated, rather the variable x may also be a function of other variables (e.g., x=f(y, t)).

The term “processor” is generally understood to refer to a hardware component, such as a processing unit of a computer system.

The term “sensor,” as used herein, refers to a converter or instrument that measures a physical quantity or quality and converts the measurement into electrical signals which can be read, observed, stored, and/or understood by an observer or by another instrument. A sensor may comprise electrodes and associated sensor electronics integrated into a common structure such as an electrode pad or may comprise electrodes and sensor electronics that are disposed remotely from one another, such as electrodes coupled to a remotely positioned processor (e.g., positioned at another location on a user or garment) or other circuitry using an electrically conductive structure such as a conductive trace, wire, cable, or the like, for example. Biopotential sensors may include but are not limited to electromyography (EMG) sensors, ECG sensors, respiration, galvanic skin response (GSR), or others. Other types of sensors may also be incorporated into the devices described herein. These sensors may include but are not limited to accelerometers (single or multi-axis), GPS sensors, galvanic skin response (GSR), bioimpedance, gyroscopes, bend-angle measurement (flex) sensors (to measure joint angle or joint angles), etc.

As used herein, the terms “signal” may take the form of an electromagnetic or electrical current that carries data from one system or network to another. In electronics, a signal is often a time-varying voltage that is also an electromagnetic wave carrying information, though it can take on other forms, such as current. In one or more embodiments, this can imply a signal over a wire-based communication, e.g., using Universal Serial Bus (USB), Ethernet, a serial interface (such as RS-232, RS-485, etc.), a parallel interface (such as Centronics) or even a simple electric connection or alternatively a wireless interface via a wireless communication protocol, such as NFC or Bluetooth™, for example. However, it will be appreciated that other types of wireless communications may be used, including any wireless communication protocol developed for smart phones and similar devices.

The term “state” as used herein refers to how a computer program stores data in variables, which represent storage locations in the computer's memory. The contents of these memory locations, at any given point in the program's execution, is called the program's state.

The term “switch” as used herein means a system element that logically connects two or more ports to allow data units to be routed from one port to another. In one or more embodiments, the switch may include a number of ports, which are physical interfaces between the buffer and logic and the end points.

The term “user input device” as used herein is intended to have a broad definition and encompasses many variations on well-known input devices, which are capable of detecting user input from a user. The user input device can, for example, be a key, button, keyboard, mouse button, touchpad button, etc. In one or more embodiments, the user input device may be a sensor or other input device capable of transmitting a system trigger or user input.

The term “wireless communication device” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. The wireless communication signals used in the present invention can be radio frequency (RF) signals, ultra-wide band communication signals, or Bluetooth communications or any other type of signal suitable for wireless communications.

### Detailed Description of Exemplary Embodiments

The present innovation provides a controller that switches from on/off based on set parameters to control one of a wide variety of electronic devices. In one or more embodiments, the control device comprises (a) an electromyography (EMG) sensor and (b) an accelerometer. In one or more embodiments, a control device can utilize just one of the sensors. In one or more embodiments, other types of switches; e.g., spatial switches and jelly bean switches, etc., can be used. Switches can be placed on various locations on the user such as a finger or toe.

In one or more embodiments, the multiplatform communication and control system (MCACS) controller receives data input from one or more sensors. One or more embodiments can utilize standard electrocardiogram (EKG) electrodes. The device can be in multiple pieces or a unitary product. The electrodes can be attached directly to the unit body, wirelessly coupled, or connected by electrical leads. Other sensors may be utilized in the system, such as a proximity sensor, photodetector, a Hall-effect sensor, a radio frequency identifier (RFID) sensor, a biomedical sensor (such as electromyography, a moisture sensor, a fluid sensor, a temperature sensor, an electrodermal activity sensor, a chemical presence sensor, a biological presence sensor, sound sensor, vibration sensor, and a pH level sensor), and a force sensor that may sense a mechanical force such as a pressure sensor or a flex sensor.

In one or more embodiments, the sensor can be an activity sensor, which generates a signal indicative of patient activity (e.g., patient movement or patient posture transitions). For example, an activity sensor may include one or more accelerometers, such as one or more single-axis, two-axis or three-axis accelerometers, capable of detecting static orientation or vectors in three-dimensions. An example accelerometer is a micro-electromechanical accelerometer. In other examples, an activity sensor may alternatively or additionally include one or more gyroscopes, pressure transducers, piezoelectric crystals, or other sensors that generate a signal that changes as a function of user activity.

In one or more embodiments, the volitional electrical potential is used by the controller as a logical control input. A logical control or triggering command resembles a digital logic or on/off signal. In the case of a volitional electrical potential, the on/off signal is tailored to change state upon the user applying the volitional electrical potential.

The present invention provides user interface concepts, principles and techniques that can be translated into software algorithms to provide rich functionality, convenience, flexibility and ease-of-use to users. Further, the disclosed concepts/principles/techniques can lead to easier implementation of the gesture recognition algorithms. Note that these concepts, techniques and principles can be used with controllers described elsewhere as well as with any other devices that can track user's head/face/bodily motions, facial expressions and gestures to control or communicate with any electronic devices. Further, the UI concepts described herein can be used to not only control an electronic device distinct from the controller, but also the controller and/or the controlling system itself. For the purpose of simplicity, the rest of the document will use the term “controller” to include “controlling systems” as well. Further, it is also understood that controllers themselves can be electronic devices; therefore, any mention of “controlling/communicating with an electronic device” can also include controlling/communicating with the controller itself.

At least a portion of control circuitry can be implemented on a personal computing device. In one aspect, the personal computing device can be a personal digital assistant, a personal entertainment device, a mobile phone, a laptop computer, a tablet personal computer, a wearable computing device (e.g., a fitness band, an item of clothing, attire, or eyewear incorporating computing capability), a networked computer, a computing system comprised of a cluster of processors, a computing system comprised of a cluster of servers, a workstation computer, and/or a desktop computer. In various aspects, a personal computing device includes one or more of a portable computing device, a mobile computing device, and a thin client computing device, for example.

Embodiments of the disclosed technology provide reliable and fast communication by a user through an interface, which detects the intent of the user. Embodiments of the disclosed technology enable people with severe speech and motor impairments to interface with computer systems for the purpose of typing in order to establish and maintain seamless spontaneous communication with partners in face-to-face situations, as well as in remote environments such as Internet chat, email, or telephone (via text-to-speech). In addition, embodiments also enable the target population to access information available on the Internet through a computer. In an embodiment, healthy humans may also utilize the proposed interface for various purposes.

The systems and methods of the present invention are adaptable and, in some embodiments, can include additional sensors for multiple applications. In some embodiments, the systems and methods of the present invention can be integrated with, for example and not limited to, electro-oculogram (EOG), microphones, accelerometers, gyroscopes, miniature cameras, and flow and/or pressure sensors, as well as electropalatography, electromyography (EMG) and electroencephalography (EEG) electrode arrays for detecting tongue contact with the palate, muscle movement and/or activity, and brain activity.

In order that the invention may be readily understood and put into practical effect, various embodiments will now be described by way of examples and not limitations, and with reference to the figures.

According to aspects of the present disclosure, a multiplatform communication and control system enables a readily customizable user interface, such as an augmentative and alternative communication device (AACD), that provides a full complement of access methods for a clinician to trial with a user—often a person with a profound motor or cognitive disability. Notably, the user interface remains unchanged with the selection of a different access method. Therefore, it is easier for the clinician to gauge which method best serves the user. In other words, this determination is simplified because, while the “cause” is modified, the “effect” is held constant.

In one or more embodiments, a multiplatform communication and control system includes one or more user input devices such as sensors or biosignal electrodes attachable to a user. A controller is communicatively coupled to one or more user input devices, a user interface device, and a switch-controlled device. The controller presents a configuration user interface on the user interface device including selectable configurations for access modes. The controller assigns one or more of the biosignal electrodes according to a current selected configuration of an access mode. The controller detects a volitional user input corresponding to a change in a particular signal detected by a particular biosignal electrode. The controller identifies the user input based on the current selected configuration and the detected volitional user input and switches the switch-controlled device based on the detected user input.

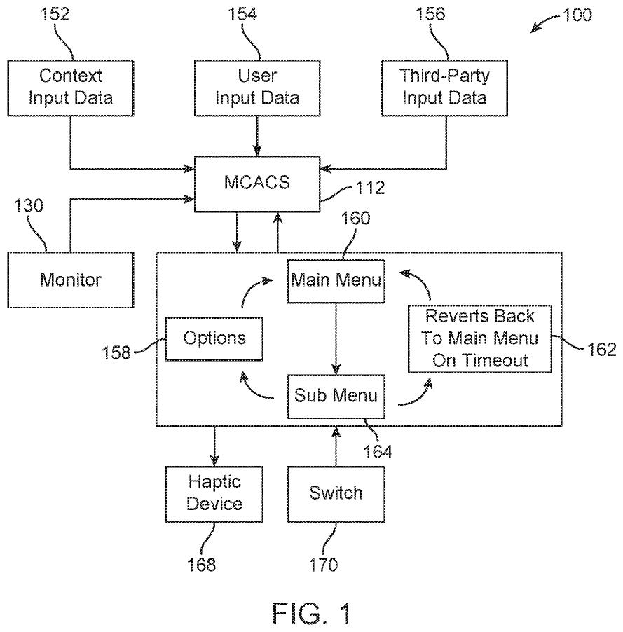

FIG. 1 exemplarily illustrates an environment 100 of a multiplatform communication and control system (MCACS), according to an embodiment of the present invention. The system comprises one or more input devices and a multiplatform communication and control system (MCACS) controller 112. The input device includes one or more haptic devices 168 and one or more switches 170. In one embodiment, the haptic device 168 and the switch 170 is provided a single integral unit. In another embodiment, the haptic device 168 and the switch 170 are provided as two separate units. In one or more embodiments, the switch 170 includes a muscle interface device. In one or more embodiments, a

In one or more embodiments, the haptic device may include, for example, a vibratory mechanical stimulator that delivers a cyclical or vibrating mechanical stimulus to the skin of the user. Vibratory mechanical stimulators can include, for example, various types of vibrating mechanical devices, e.g., electromechanical, piezoelectric, movable coil, electrostatic, magnetostrictive, isodynamic, and/or MEMS devices, for example as used for manufacturing small-scale speakers and microphones.

In one or more embodiments, one or more muscle activity sensors in and/or on-board the wearable muscle interface device may include electromyography (EMG) sensors and/or mechanomyography (MMG) sensors to detect electrical signals and/or vibrations, respectively, produced by muscles in the user's arm and to provide one or more signal(s) in response to the detected electrical signals and/or vibrations. In addition to EMG and/or MMG sensors, various other types of sensors may be used to detect gestures made by the user. For example, inertial sensors such as accelerometers and/or gyroscopes may be used to detect signals generated by motion of the arm of the user in response to the user performing the physical gesture. The wearable muscle interface device may include one or more accelerometer sensors that, in use, detect signals generated by motion of the arm of the user and/or measure characteristics of gestures made by the user, including gestures involving the elbow or even the shoulders of the user. When used together with EMG and/or MMG sensors for detecting gestures, the accelerometer sensors may be utilized to increase the variety of control inputs that may be generated for direct interaction with a controller 112. Furthermore, in various embodiments the gesture-based interaction systems, devices, and methods described herein may be combined with other forms of touchless control, including without limitation: voice/speech-based control techniques such as Siri®, control techniques based on eye/vision tracking and/or blinking, electroencephalography (EEG), or the like.

The input device is configured to receive data input of at least one of a context input data 152, a user input data 154, and a third-party input data 156. In one example, context input data 152 includes a time of day, for example, 3:00 μm which is related to the time a child coming home. In another example, the context input data 152 includes physiological parameters, for example, heart rate, blood pressure, oxygen levels, glucose level, insulin levels.

In yet another example, the context input data 152 includes occurrences, for example, ringing of doorbell, person entering a room. In yet another example, the context input data 152 depends on the menu 160 the user is accessing in the controller 112. The user input data 154 includes input data from the user. The third-party input data 156 includes input data from people other than the user, for example, doctors, assistants, caretakers, or other third parties, including through one or more input devices. The third-party input data 156 can be by controller, sensors such as RFID, voice or facial recognition sensors, audio or visual input devices, e.g., cameras and microphones, or other user interface. The user interface may be a touch sensitive surface, or can be any other type of user interface such as a mouse, touchpad, mini-joystick, scroll wheel, trackball, game pads or game controllers, button, dial, voice command input, etc. The third-party input data 156 includes from devices connected in real time via any type of communication link, including but not limited to electronic, cellular, wireless, wi-fi, optical, infrared, acoustic, Bluetooth, USB, Firewire, Thunderbolt or Ethernet.

The user input data 154 includes volitional user input of the user. The input device is configured to detect volitional user input of the user. For example, the input device is configured to detect movement of a finger or extremity, which triggers a switch signal. The controller 112 is configured to receive switch signal as the user input data 154. The context input data 152, the user input data 154, and the third-party input data 156 are commonly referred to as input data. The controller 112 is configured to receive input data from the input devices and provide response to the input using haptic feedback. The controller 112 is configured to provide haptic feedback to the user via the haptic devices 168.

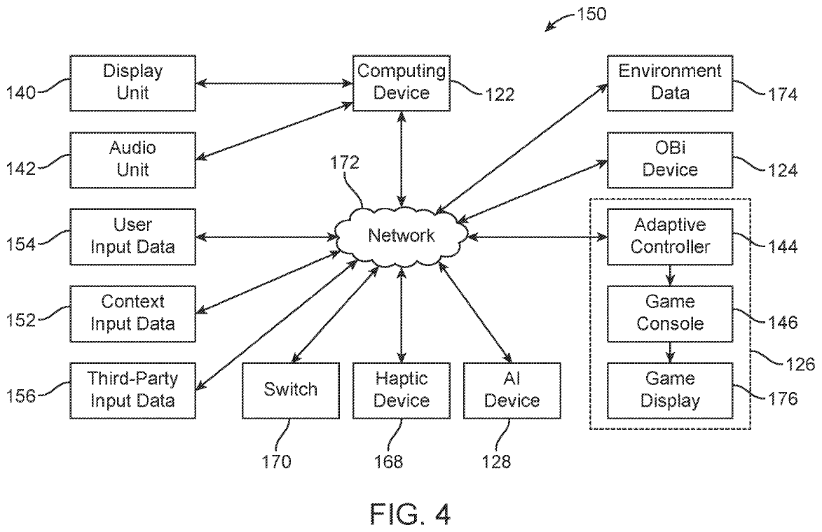

In an example, the user desires to operate an external device, for example, an adaptive eating device 124 (shown in FIG. 4). An example adaptive eating device is the OBI dining robot (Desin, LLC, Jacksonville, FL). The controller 112 is configured to receive input data related to the desire to operate the external device. The controller 112 is configured to provide one or more outputs in response to the input data. For example, the controller 112 is configured to provide at least two options including option A to select food and option B to deliver food. The options are provided to the user in the form of haptic feedback via the haptic device 168. The controller 112 is configured to provide first haptic feedback, which indicates option A and provide second haptic feedback, which indicates option B. The user could select any option, which is detected by the input devices as volitional user input. If the user did not select any options provided by the controller 112, the controller 112 is configured to send a warning for timeout as haptic feedback to the user.

In another embodiment, the system comprises one or more haptic devices 168 including a first haptic device and a second haptic device. The system further comprises one or more switches 170 including a first switch and a second switch. For example, the first haptic device and the first switch is disposed at the right hand of the user and the second haptic device and the second switch is disposed at the left hand of the user. In one embodiment, the first haptic device and the first switch is provided as a single integral unit and the second haptic device as the second switch is provides as a single integral unit. In another embodiment, the first haptic device and the first switch is provided as a separate unit and the second haptic device as the second switch is provided as a separate unit. For example, if the user is playing a game, the controller 112 is configured to provide option 1 “aim down sights” as first haptic feedback signal, option 2 “reload” as second haptic feedback signal, option 3 “swap weapons” as third haptic signal, option 4 “crouch” as fourth haptic signal, option 5 “go up” as fifth haptic signal and option 6 “jump” as sixth haptic signal. The controller 112 is configured to provide the first haptic signal, the second haptic signal and the third haptic signal via the first haptic device. Further, the user is enabled to select at least one of the option 1, option 2, and option 3 via the first switch.

The controller 112 is configured to provide the fourth haptic signal, fifth haptic signal and the sixth haptic signal via the second haptic device. Further, the user is enabled to select at least one of the option 1, option 2, and option 3 via the second switch. In one embodiment, the switch 170 includes a spatial (accelerometer) type switch. In another embodiment, the switch 170 includes a wireless switch where a movement of a finger or extremity causes a switch signal (like a mouse click) in order to make a selection of the options.

The system further comprises one or more monitors 130 to display information. The controller 112 is configured to display the options provided to the users as haptic feedback signal. In one embodiment, the controller 112 is configured to provide options 158, including, but not limited to, option 1 as first haptic signal and option 2 as second haptic signal. If the user selects option 1, the controller 112 is configured to provide option 3 as third haptic signal, option 4 as fourth haptic feedback as a response to the selection of option 1. The main menu 160 includes option 1 and option 2 and the sub menu 164 includes option 3 and option 4. If the user did not select any the option 3 and option 4, the controller 112 reverts to the main menu 160 and sends an alert to the user regarding time out 162 in the form of haptic signal. Thus, the system receives volitional user input of the user and provides response to the input using haptic feedback. The present invention could be used by, but not limited to, a user relying on hearing aids, a user having hearing impairment, a user who does not want others to hear their conversation/commands, and a user who is in a noisy environment. In this way, the user 110 may access and control or otherwise interact with the controller 112 in an inconspicuous and hands-free manner.

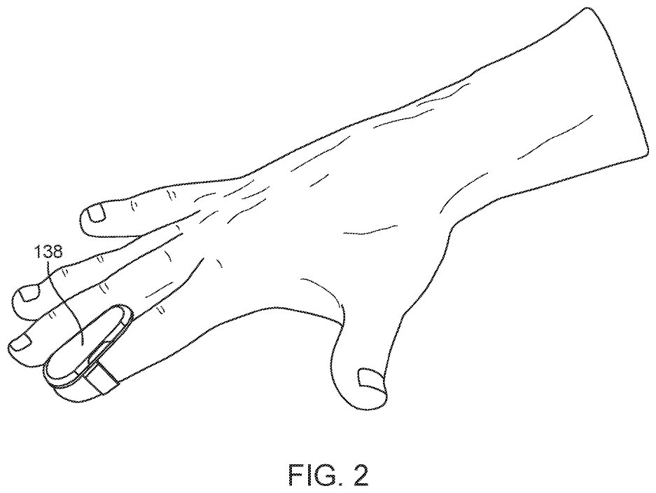

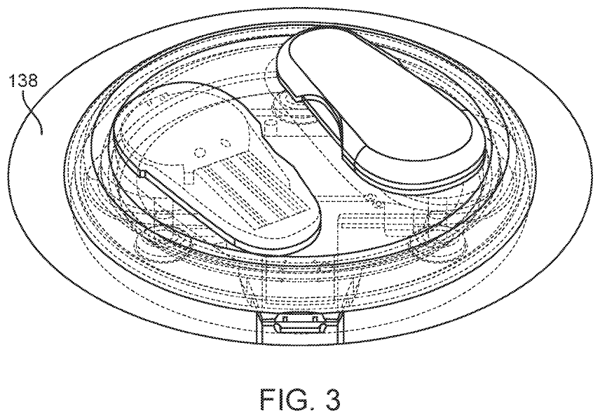

FIG. 2 exemplarily illustrates a user wearing a wearable device 138, according to an embodiment of the present invention. FIG. 3 exemplarily illustrates a perspective view of the wearable device 138 of FIG. 2 placed on a charger base 139 wherein the charger base 139 is configured to recharge one or more internal batteries (not shown) associated with the wearable device 138. The input device includes the wearable device 138. In one or more embodiments, the wearable device 138 includes replaceable batteries or other power source. The wearable device 138 includes at least one of the haptic devices 168 and the switch 170.

FIG. 4 exemplarily illustrates an environment 150 of a computing device 122 of the system, according to an embodiment of the present invention. The system further includes a computing device 122 associated with the user. The computing device 122 may be, for example, a desktop computer, a laptop computer, a mobile phone, a tablet, a personal digital assistant, and the like. The computing device 122 is configured to provide the user an interface to interact with the controller 112 and other external device, for example, an OBI device 124, a gaming device 126 including an adaptive controller 144, a game console 146 and a game display 176, artificial intelligence devices 128, switches 170 and haptic devices 168. The computing device 122 is configured to interact with the controller 112 and the external devices via a network 172.

The network 172 generally represents one or more interconnected networks, over which the computing device 122, controller 112 and external devices could communicate with each other. The network 172 may include packet-based wide area networks (such as the Internet), local area networks (LAN), private networks, wireless networks, satellite networks, cellular networks, paging networks, and the like. A person skilled in the art will recognize that the network 172 may also be a combination of more than one type of network. For example, the network 172 may be a combination of a LAN and the Internet. In addition, the network 172 may be implemented as a wired network, or a wireless network or a combination thereof. Further, the network 172 includes a Bluetooth network.

The computing device 122 further includes an interface, for example, a mobile application that allows the computing device 122 to communicate with the controller 112 and other devices connected to the controller 112. The computing device 122 is configured to function as both input and output device. The computing device 122 further comprises a display unit 140 and an audio unit 142 for communication with the user. The computing device 122 is configured to receive at least one of a context input data 152, a user input data 154, and a third-party input data 156 and communicates the input data to the controller 112. The computing device 122 is configured to receive input data from the switch 170 and send output data to the haptic device 168. The computing device 122 is further configured to connect with one or more external devices, for example, a smart device, to receive data about the environment 174 (also referred as environment data 174) of the user and enables the user the control a heater to adjust the temperature of the environment of the user. The user is enabled to control the heater and the smart device via haptic feedback. The controller 112 is further configured to enable the user to communicate with others, for example, pets, family and caregivers, by controlling the computing device 122 via the haptic feedback. The controller 112 is further configured to enable the user to control the computing device 122 via haptic feedback to display messages.

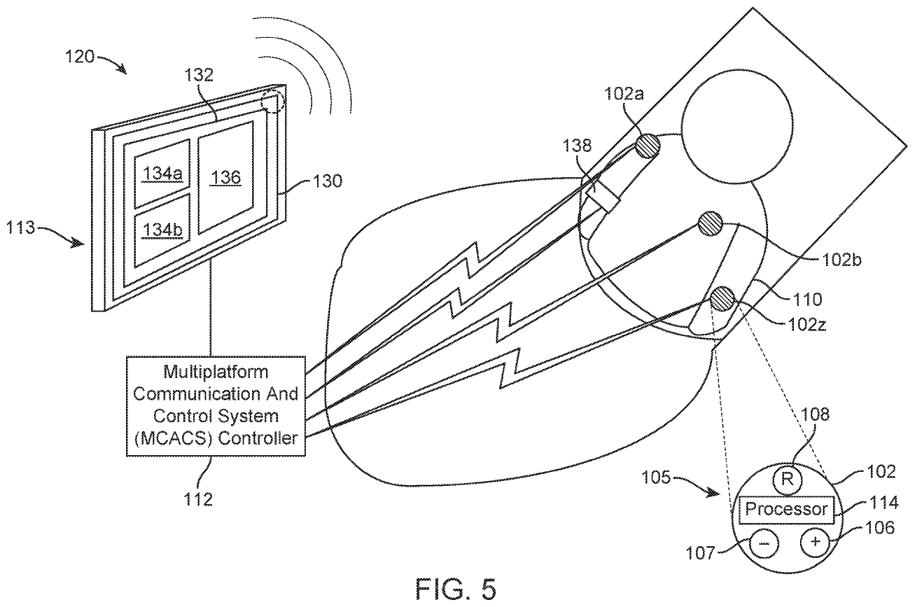

FIG. 5 illustrates an environment 120 of a multiplatform communication and control system. The system comprises one or more wearable user interface device 138, one or more input devices, and a multiplatform communication and control system (MCACS) controller 112. The wearable device 138 comprises at least one transducer. The wearable device 138 is in communication with the multiplatform communication and control system (MCACS) controller 112 that centrally performs the processing functions of the transducer.

The input device is configured to detect at least one input signal. The input signal includes at least one of a user input signal and an external event occurrence signal. The input device comprises one or more electromyography (EMG) assistive technology devices 102a, 102b, and 102z for multi-modal inputs by user 104. The electromyography (EMG) assistive technology devices 102a, 102b, and 102z are collectively represented using numeral “102”. The electromyography (EMG) assistive technology devices 102 enable automatically customizable and adaptable detection of volitional user bioelectrical inputs.

The electromyography (EMG) assistive technology devices 102 each include a set of bioelectrical electrodes 105 such as a first active electrode 106, a second active electrode 107 and a reference (“R”) electrode 108 that are adhered to a user 110. In other embodiments, each electrode 106-108 is individually adhered to the user 110 and interfaced to a multiplatform communication and control system (MCACS) controller 112 that centrally performs the processing functions of each electromyography (EMG) assistive technology device 102. Each electromyography (EMG) assistive technology device 102 includes a processor 114 that supports dynamic and static adjustments to switching threshold that accommodate specific requirements of the user 110 as compared to other individuals or as compared to changing characteristics of the user 110. In one or more embodiments, each electromyography (EMG) assistive technology device 102 is a mesh accessible surface electromyography controller, wearable by a user 110, for capturing electromyography and electrocardiogram certain muscles, including the heart. The electromyography (EMG) assistive technology device 110 has the ability to store the data onboard for extended periods, and to send the data by Bluetooth or Wi-Fi or other wireless means to a receiver. The electromyography (EMG) assistive technology device 102 can analyze the data onboard or send data to a receiver for analysis by code or by a person. When analyzing the data onboard, the electromyography (EMG) assistive technology device 102 can assess certain intentions of the user 110. The electromyography (EMG) assistive technology device 102 monitors parameters and sensor systems and incorporates algorithms that continually adapt to abilities of the user 110.

The controller 112 is configured to determine one or more output options for the input signal. The options include a first option and a second option. The controller 112 is configured to assign the first option to a first haptic signal and the second option to a second haptic signal. In one embodiment, the user is enabled to receive multiple haptic signals corresponding to different options for user selection. In one or more embodiments, each haptic signal can have a unique pattern such that the user can differentiate each choice.

The controller 112 is communicatively coupled, either wirelessly or wired, to the wearable device 138. The controller 122 is configured to control the wearable device 138 to provide a first haptic simulation corresponding to the first haptic signal and a second haptic simulation corresponding to the second haptic signal to the user. The controller 112 is configured to detect a volitional user input corresponding to at least one option selected by the user and communicating the option selected by the user.

The MCACS controller 112 is communicatively coupled, either wirelessly or wired, to the user input devices 102a, 102b, and 102z to detect the “cause”. The MCACS controller 112 is communicatively coupled, either wirelessly or wired, to one or more user interface devices 113 and wearable device 138 to prompt the “effect”. For example, the cause may be external event occurrence signal including a question “did you want dinner?” and the effect may include providing a haptic signal corresponding to option “yes” and a haptic signal corresponding to option “no”. The user input device 102 is configured to detect the response. For example, the response may be the option “yes” and the user lifts a finger to select the option “yes”. The controller 112 is configured to communicate the response.

A system monitor 130 can be communicatively coupled to the MCACS controller 112. The system monitor 130 supports one or more of: (i) providing a user interface for configuring individual user input devices or electromyography (EMG) assistive technology devices 102; and (ii) a user interface 132 for configuring the “cause” handled by the MCACS controller 110. For example, the user interface 132 for control system software can graphically depict switches 134a-134b that are actively assigned to user input devices 102a, 102b, and 102z in accordance with configuration settings 136. In one or more embodiments, other types of switches such as mechanical, positional, and optical can be used instead of, or in addition to, biosignal-based switches.

In one or more embodiments, the multiplatform communication and control system includes, or is interfaced to, one or more of: (i) an eye tracking device such as a Trilogy model of a Windows Surface computer; an Apple iPad; (iii) an Xbox adaptive controller; (iv) an Xbox game console; (v) one or more touchscreen displays; and (vi) Bluetooth speaker, which enable the assisted user to interact and control the MCACS controller 112 using haptic feedback.

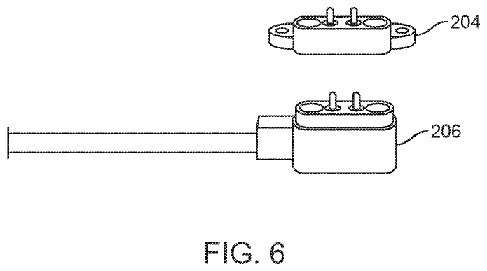

FIG. 6 exemplarily illustrates a perspective view of a magnetic connector 204, 206 that connects with a haptic motor, according to an embodiment of the present invention. The haptic motor in communication with the controller 112 configured to provide haptic feedback to the user.

Referring to FIG. 5, the controller 112 performs the functionality of the cause-and-effect control of the system. The controller 112 includes over-the-air (OTA) communication subsystem that communicates with user interface devices 113. Controller 112 provides computing and data storage functionality in support of OTA communication with user interface devices 113. Controller includes data storage subsystem and input/output (I/O) subsystem that are communicatively coupled to each other via a system interlink.

Controller 112 controls the OTA communication subsystem, user interface device 113, and other functions and/or operations. These functions and/or operations include, but are not limited to, application data processing and signal processing. Controller 112 may use hardware component equivalents for application data processing and signal processing. For example, controller 112 may use special purpose hardware, dedicated processors, general purpose computers, microprocessor-based computers, micro-controllers, optical computers, analog computers, dedicated processors and/or dedicated hard wired logic. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

In one or more embodiments, controller 112, via OTA communication subsystem, performs multiple types of OTA communication with external OTA communication system. OTA communication subsystem can communicate with one or more personal access network (PAN) devices within external OTA communication system, such as smart watch, tablet or other portable device that is reached via Bluetooth connection. In one or more embodiments, OTA communication subsystem communicates with one or more locally networked devices via a wireless local area network (WLAN) link provided by WLAN node. WLAN node is in turn connected to wide area network, such as the Internet. In one or more embodiments, OTA communication subsystem communicates with radio access network (RAN) having respective base stations (BSs) or cells. RANs are a part of a wireless wide area network (WWAN) that is connected to a wide area network and provides data services. In one or more embodiments, antenna subsystem includes multiple antenna elements that are individually tuned to selected RF bands to support different RF communication bands and protocols. Antenna elements can be used in combination for multiple input multiple output (MIMO) operation for beam steering and spatial diversity.

Controller 112 includes a processor subsystem, which executes program code to provide functionality of the multiplatform communication and control system. Processor subsystem includes one or more central processing units (CPUs) (“data processor”). In one or more embodiments, the processing subsystem includes a digital signal processor (DSP). Controller 112 includes system memory, which contains actively used program code and data. In one or more embodiments, system memory includes therein a plurality of such program code and modules, including applications such as game application and other applications. System memory can also include operating system (OS), firmware interface such as basic input/output system (BIOS) or Uniform Extensible Firmware Interface (UEFI), and platform firmware. These software and/or firmware modules have varying functionality when their corresponding program code is executed by processor subsystem or secondary processing devices within the multiplatform communication and control system. Data storage subsystem provides nonvolatile storage accessible to controller 112. I/O subsystem 209 includes input and output devices such as a user interface device 113. Power for the multiplatform communication and control system can be provided by a rechargeable power supply.

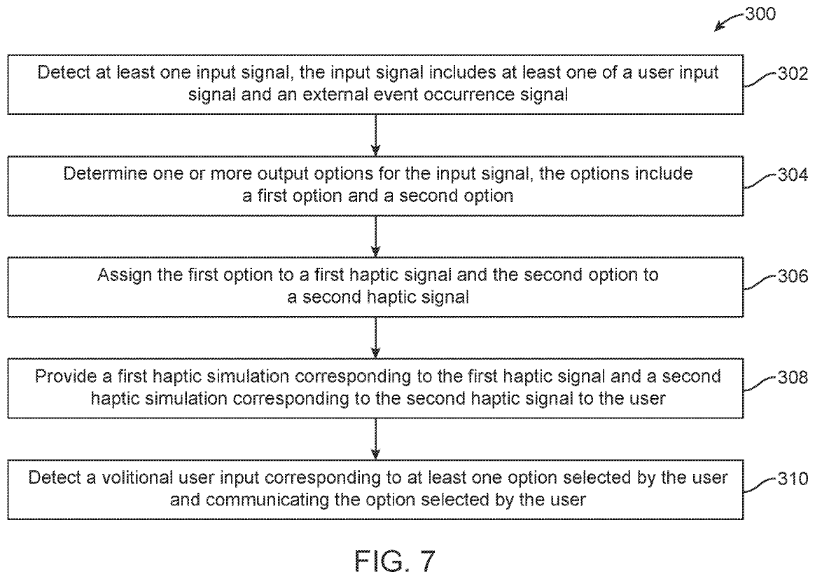

FIG. 7 exemplarily illustrates a flowchart 300 of a method for providing a multiplatform communication and control, according to an embodiment of the present invention. At step 302, the controller 112 of the system is configured to detect at least one input signal. The input signal includes at least one of a context input data 152, a user input data 154, and a third-party input data 156. At step 304, the controller 112 is configured to determine one or more output options for the input signal. The options include a first option and a second option. At step 306, the controller 112 is configured to assign the first option to a first haptic signal and the second option to a second haptic signal. In another embodiment, the user is enabled to pre-configure haptic signal to the options. At step 308, the controller 112 is configured to provide a first haptic simulation corresponding to the first haptic signal and a second haptic simulation corresponding to the second haptic signal to the user. The haptic simulation or signal is provided using the wearable device 138. The controller provides haptic feedback in cycles 1, 2, 1, 2. For example, 1 represents first haptic feedback and 2 represents second haptic feedback. At step 310, the controller 112 is configured to detect a volitional user input corresponding to at least one option selected by the user and communicating the option selected by the user. In one embodiment, the user is enabled to select an option, for example, via the NeuroNode.

The system of the present invention enables the user or patient to control the system to communicate without visual or audio inputs. The system provides a haptic based interface, which makes the system useable in noisy environments, for example.

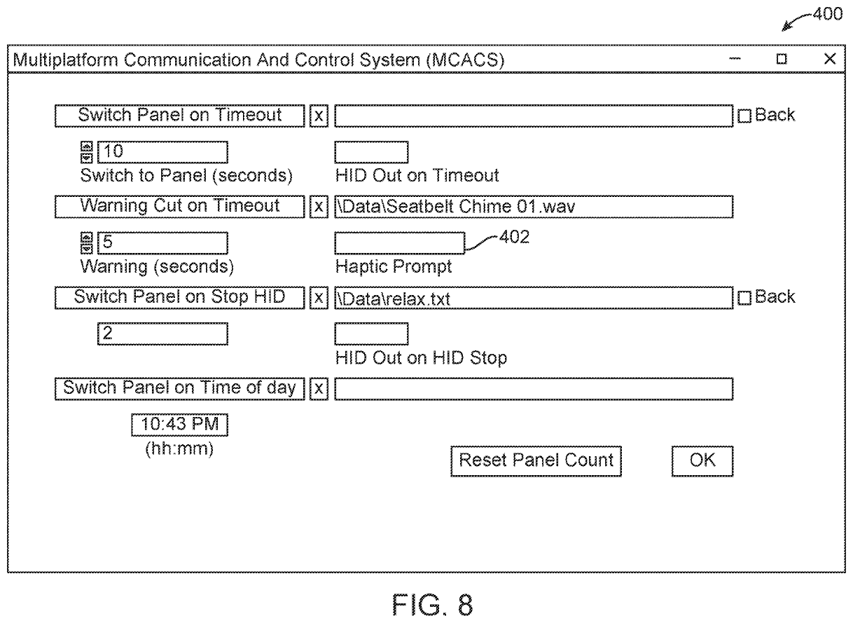

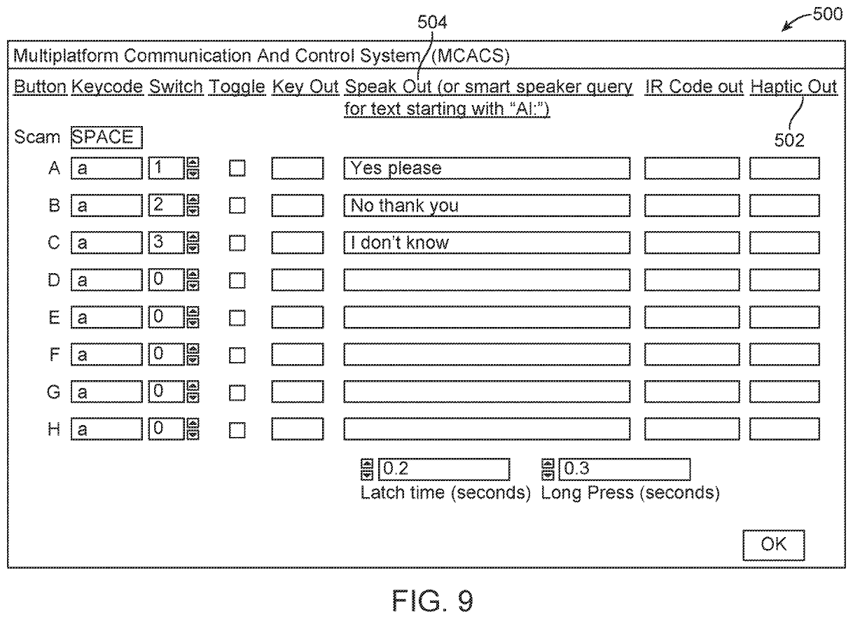

FIG. 8 exemplarily illustrates a screenshot 400 of user interface, which allows the user to configure haptic feedback, according to an embodiment of the present invention. The controller 112 is configured to allow a user to configure specific haptic signatures for each input signal via the haptic prompt option 402. A user is thereby able to distinguish the meaning of various haptic signals by their specific haptic signatures. FIG. 9 exemplarily illustrates a screenshot 500 of switch design to configure a haptic signal for an input signal, according to an embodiment of the present invention. For example, the input signal involves a question “do want to have dinner” and the system could response with at least one option 504 including yes please, no thank you and I don't know. The user is enabled to configure a response to the options “yes please, no thank you and I don't know” using the option haptic out 502.

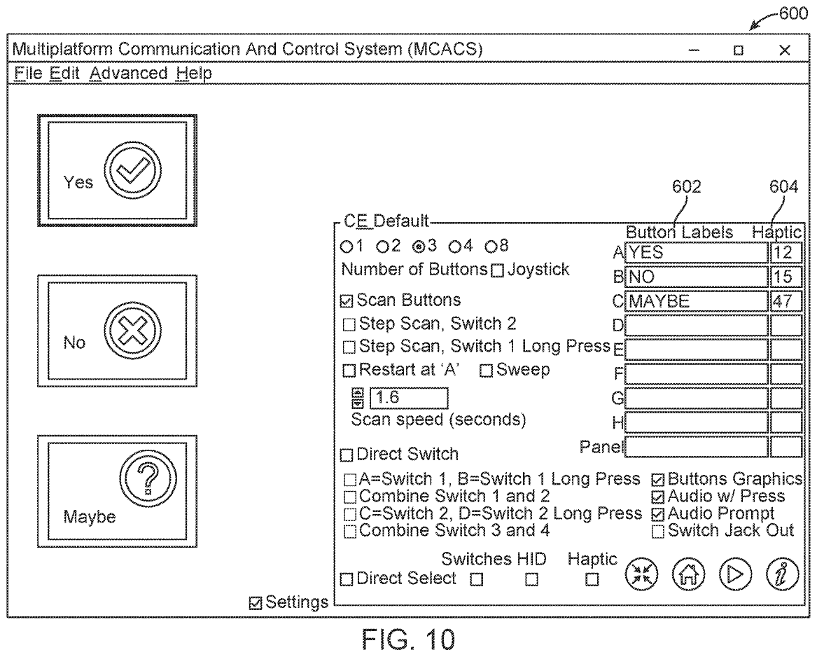

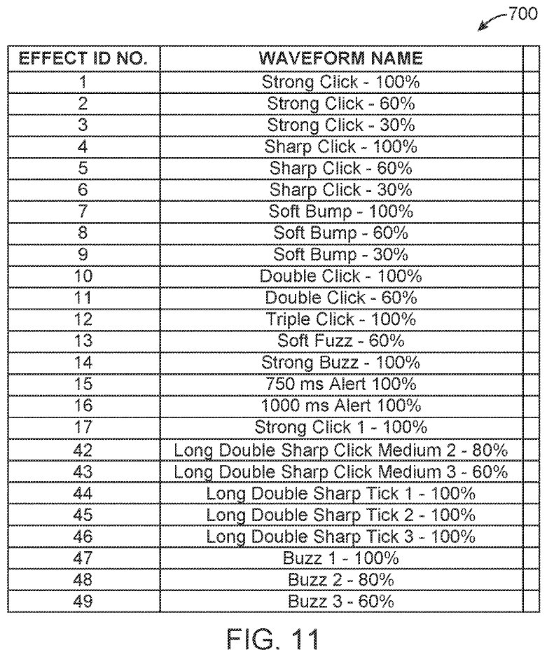

FIG. 10 exemplarily illustrates a screenshot 600 of the system showing one or more output options and corresponding haptic signal for each output option, according to an embodiment of the present invention. For example, the input signal involves a question “do want to have dinner” and the system could response with at least one option 602 including “yes”, “no”, and “maybe”. For each option, the controller is configured to prompt the user with the corresponding haptic output 604 signal. FIG. 11 exemplarily illustrates a screenshot 700 of the system showing list of output options and corresponding haptic signal for each output options, according to an embodiment of the present invention. The system enables the user to configure a particular haptic signal for each output option.

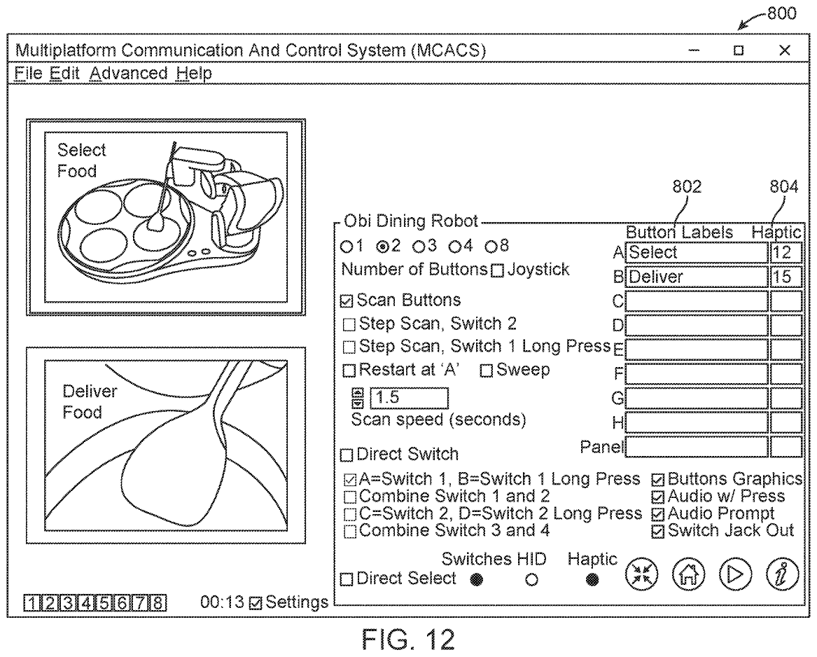

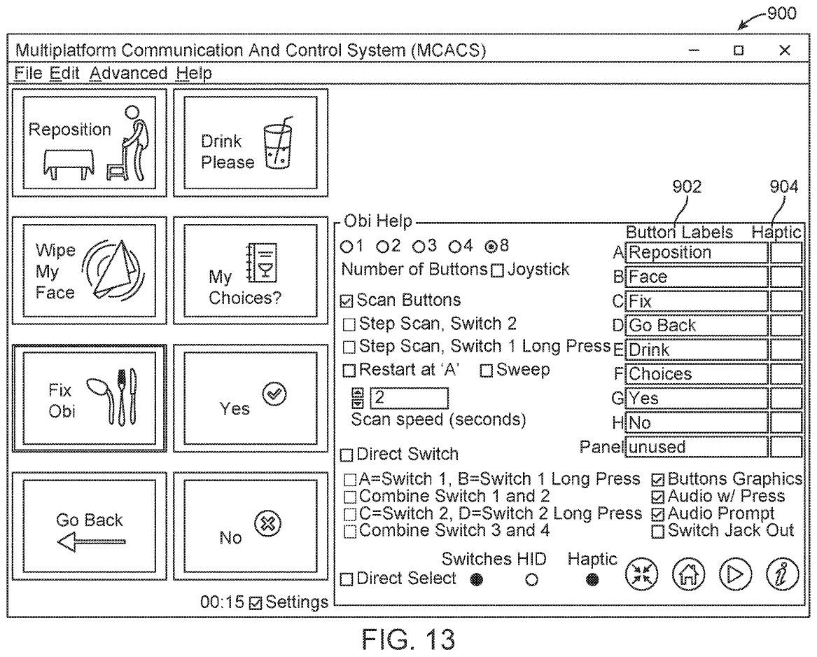

FIG. 12 exemplarily illustrates a screenshot 800 of the system showing one or more output options and corresponding haptic signal for each output option, according to another embodiment of the present invention. For example, the input signal involves a question related to food and the system could respond with at least one option 802 including select food and deliver food. For each option, the controller is configured to prompt the user with the corresponding haptic output signal 804. FIG. 13 exemplarily illustrates a screenshot 900 of the system showing one or more output options and corresponding haptic signal for each output option, according to yet another embodiment of the present invention. According to this embodiment, the system is configured to provide haptic 904 signal for options 902, including, but not limited to, “reposition”, “drink please”, “wipe my face”, “fix OBI”, “yes”, “no”, and “go back”. In one embodiment, there is no haptic prompting, only audio prompting for the user.

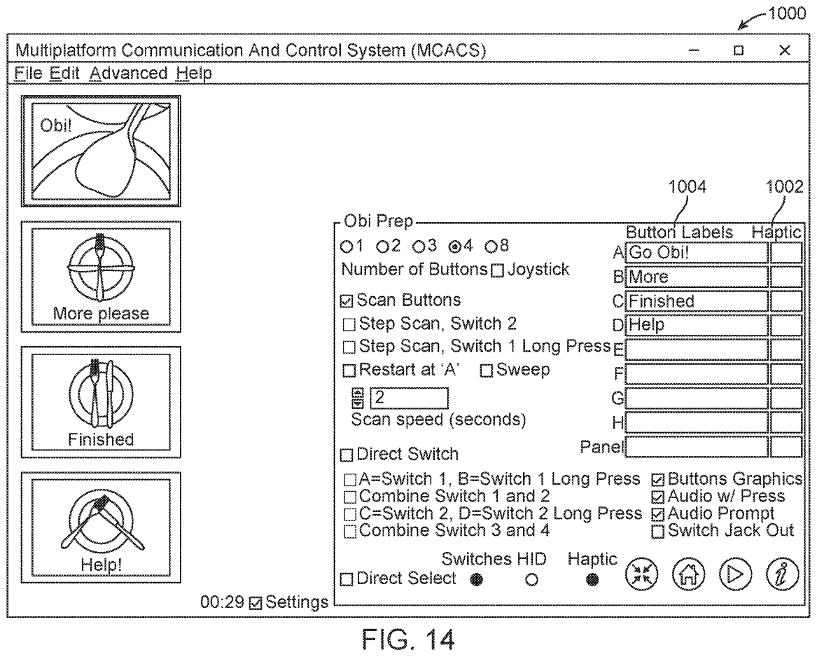

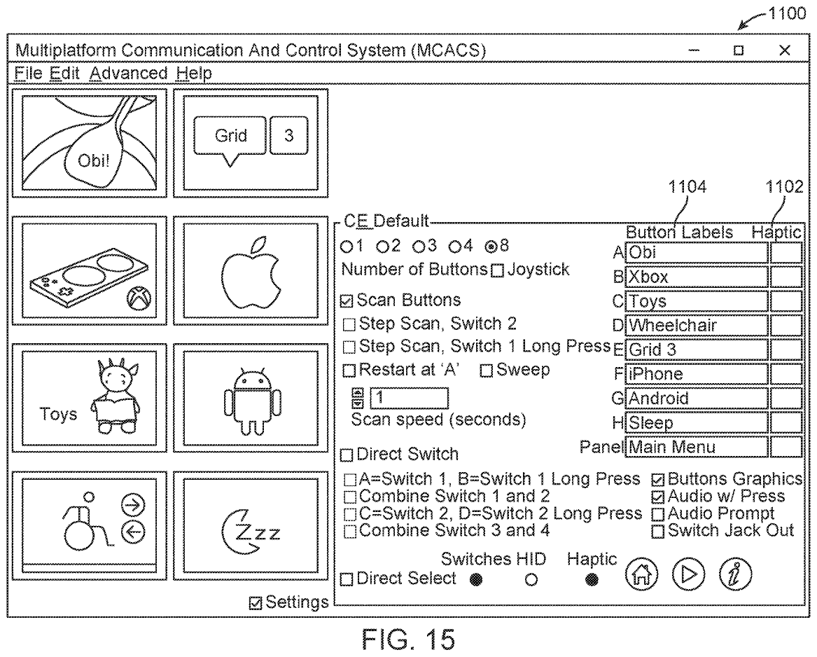

FIG. 14 exemplarily illustrates a screenshot 1000 of the system showing one or more output options and corresponding haptic signal for each output option, according to yet another embodiment of the present invention. According to this embodiment, the system is configured to provide a haptic 1002 signal for options (prompts) 1004, including, but not limited to, more please, finished, help and a command to access the OBI device 124. FIG. 15 exemplarily illustrates a screenshot 1100 of the system to configure a haptic 1102 signal to activate and control one or more devices 1104, according to an embodiment of the present invention. The devices 1104 include a game device, a toy device, a wheelchair, an Apple or Android device, and an OBI robot.

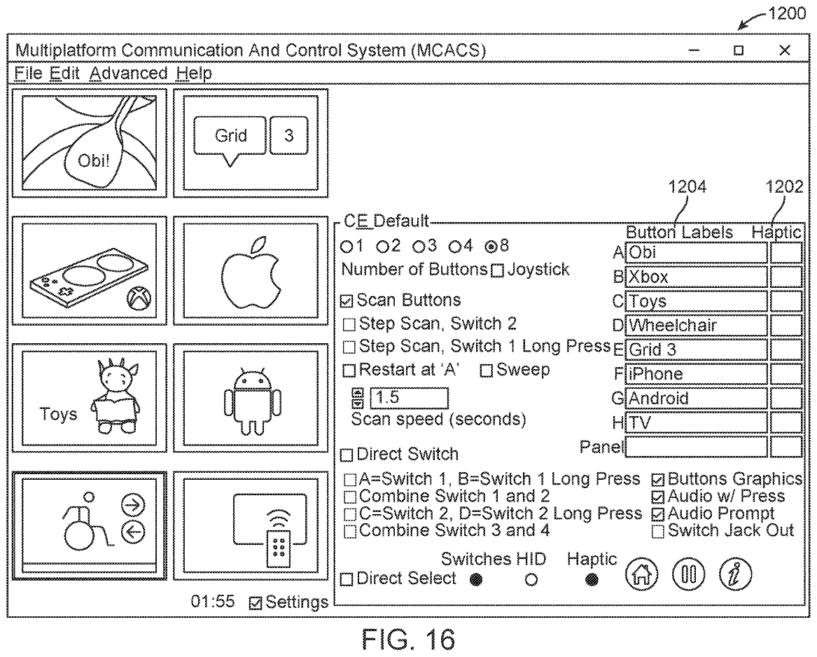

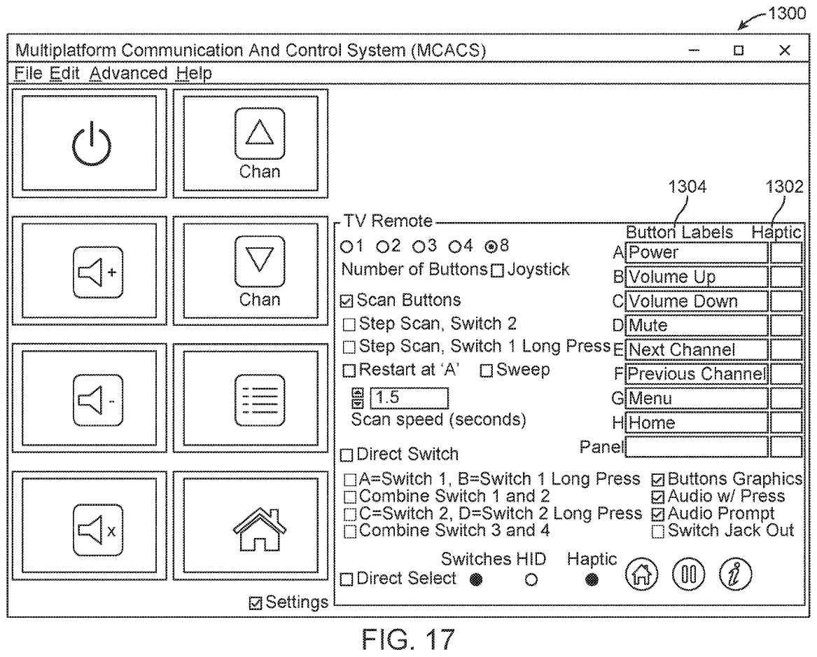

FIG. 16 exemplarily illustrates a screenshot 1200 of the system to configure a haptic 1202 signal to activate and control one or more devices 1204, according to another embodiment of the present invention. The devices 1204 include a game device, a toy device, a wheelchair, an Apple or Android device, an OBI robot and a remote device. FIG. 17 exemplarily illustrates a screenshot 1300 of the system to configure a haptic 1302 signal to activate and control one or more functions of the remote device, according to yet another embodiment of the present invention. The functions 1304 of the remote device include power, volume, mute, channel selection, menu and home.

The present disclosure includes various exemplary embodiments of systems and methods that utilize the location and context of a user and other resources to a) adjust to the current situation, b) prevent high risk situations, and/or c) respond to and manage situations. Various embodiments include collecting, aggregating, and analyzing user-related data specific to that user's condition, motivations, and usage. Such data/information can be collected from a wide variety of sensors and other data sources, including but not limited to: personal devices such as smartphones, tablets, computers, PDAs, wearables (data collection devices worn on the person, such as Fitbit, etc.), implants, Google GLASS, etc.; nearby sensors or devices such as security/video cameras, smart devices (such as smart home-related sensors, etc.), crowdsourcing data collection applications of nearby users, building/store/office Wi-Fi networks, location-sensitive beacons, etc.; and/or extended data collection mechanisms such as road traffic sensors, public video cameras or billboard displays, weather data collection sensors, law enforcement/security-related devices, etc.

In one or more embodiments, an example communications network includes a plurality of heterogeneous, differing, or different types of sensing devices configured to monitor the location and/or context of a user; and a plurality of heterogeneous, differing, or different types of interface devices each configured to engage in interaction with the user, with a support person for the user, and/or with a third party in the event that the network detects a relationship between the monitored location and/or context and a trigger predetermined in the network for the user; wherein the interaction is selected based on the trigger and the monitored location and/or context. The example communications network may include one or more server, client, cloud, peer-to-peer, and/or other devices configured to develop and/or update a profile of the user based on monitoring data from the sensing devices and/or the interaction engaged in by one or more of the interface devices.

The system can operate in a home, a nursing home, a hospital or other setting. In one or more embodiments, the system includes one or more mesh network appliances to enable wireless communication in the home monitoring system. Appliances in the mesh network can include home security monitoring devices, door alarm, window alarm, home temperature control devices, fire alarm devices, among others. Appliances in the mesh network can be one of multiple portable physiological transducer, such as a blood pressure monitor, heart rate monitor, weight scale, thermometer, spirometer, single or multiple lead electrocardiograph (ECG), a pulse oximeter, a body fat monitor, a cholesterol monitor, a signal from a medicine cabinet, a signal from a drug container, a signal from a commonly used appliance such as a refrigerator/stove/oven/washer, or a signal from an exercise machine, such as a heart rate. In one example, a user may have mesh network appliances that detect window and door contacts, smoke detectors and motion sensors, video cameras, key chain control, temperature monitors, CO and other gas detectors, vibration sensors, and others. A user may have flood sensors and other detectors on a boat. A user may have access to a panic transmitter or other alarm transmitter. Other sensors and/or detectors may also be included.

Target systems include software (such as programs that can be controlled by Boolean or dynamic data, including Assistive Technology programs); hardware (such as robotic systems which may include control and response software); firmware (such as resident software that controls a device such as a television, music or video player or recorder, smartphone, tablet, computer, environmental control system); proximity systems such as a Near Field Communication (NFC) system; analytical systems, such as a cardiography or other data analysis systems, pattern recognition systems or other data-based system; and programmed or artificial intelligence systems. In one or more embodiments, the EMG device captures physiological data and stores, analyzes, transmits, and uses the data and calculated results to display information, interface with other software and hardware systems, and control other devices.

In one embodiment, system 100 can include reporting circuitry for reporting information regarding one or more tracked data trends, or metrics. For example, reporting circuitry can be used to provide a report to one or more of the subjects, a parent, an instructor, a coach, a medical care provider, or a peer. In one embodiment, a report is provided to other parties, for example, an insurance company or a service provider (e.g., a business or other entity that provides services related to system 100 or related to monitoring use of system 100). In one embodiment, a report is provided to at least one social media contact (or ‘friend’), e.g., via a social network. Reports provided by reporting circuitry may include various types of information, including but not limited to information regarding device and system settings and usage, as well as metrics.

The device may also include a variety of computer-readable media. Computer-readable media can be any available media that can be accessed by the CPU and can include both volatile and nonvolatile media that is either removable and/or non-removable, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), Blu-ray discs (BD), compact discs (CDs), removable media or storage, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and solid state drive), magnetic cassettes, magnetic tapes, magnetic disk storage, magnetic strips, or other magnetic storage devices.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various wearable device implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The device implementations described herein may be further described in the general context of computer-executable instructions, such as program modules, being executed by a computing device. Generally, program modules include routines, programs, objects, components, data structures, and the like, that perform particular tasks or implement particular abstract data types. The wearable device implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High-Speed Integrated Circuit Hardware Descriptor Language (VHDL)) or other circuitry model which may then be used to create a physical implementation having hardware (e.g., an Application Specific Integrated Circuit).

In some embodiments, the subject is partially or completely disabled, such as for example a quadriplegic subject, and the apparatus enables the subject to control and communicate with the disabled subject's environment so that the subject can be at least partially self-sufficient.

The system will typically be a computer operated device, often including at least one microprocessor, memory, and software to control the visual display. The device will generally take input from the eye gaze sensor or sensors and convert this input into an eye gaze direction, as well as correlate this eye gaze direction with a particular visible element and eye position zone associated with this particular visible element on the device's display. The device may additionally contain communication devices, such as wired or wireless network connections to communicate to and from other outside devices, cell phone networks, and networks such as the Internet. Note that although in some embodiments this microprocessor and communication device may be internal to a device that in turn is mounted on the user's head, in other embodiments, the device may be more of a dumb device, and microprocessor(s) and communications devices may instead be outside of the device, and in some cases connected to the device by a cable.

All the above disclosed concepts/principles/heuristics/techniques/algorithms, etc. can be used in a variety of different fields and applications. Some of the examples are Augmentative and alternative communication (AAC), Assistive Technology, Speech Generation Devices, Augmented/Mixed/Virtual Reality, Desktop & Mobile Computing, Gaming, Industrial Control, Healthcare, Defense, Aviation, Transportation, Manufacturing, Product Lifecycle Management, Aerospace, & others. All the concepts/principles/heuristics/techniques/algorithms, etc. disclosed in this document can also be used with all the apparatuses/devices disclosed in the referenced documents, as well as with devices including but not limited to head worn devices such as smart glasses, smart helmets, virtual/mixed/augmented reality devices, head worn controllers, in-ear controllers, headphones, ear plugs, head bands and neck bands. Further, they are also applicable to other body worn devices such arm/wrist bands, devices utilizing wearable sensors and smart watches, devices embedded inside the user's body, as well as devices that are not physically worn in/on user's body such as smart phones, tablets, desktop computers, smart TVs, set top devices, and others that may possibly utilize image, radar, sonar, sound/voice, ultrasonic, laser and other sensors to sense any or all body action and/or physiological states.

While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A multiplatform communication and control system, comprising:
(a) one or more switches configured to be activated by a user, each switch comprises a set of user input devices configured to detect an input signal;
(b) a wearable user interface device comprising at least one haptic transducer, the transducer is configured to provide a haptic stimulation to a user of the wearable device, and
(c) a controller communicatively coupled to the one or more switches, the wearable user interface device, wherein the controller is configured to:
i. detect at least one input signal, wherein the input signal includes at least one of a user input signal and an external event occurrence signal;
ii. determine one or more output signal for the input signal, wherein the output signal includes a first option and a second option;
iiii. assign the first option to a first haptic signal and the second option to a second haptic signal;
iv. provide sequentially a first haptic stimulation corresponding to the first haptic signal and a second haptic stimulation corresponding to the second haptic signal to the user for choice selections,
v. following one of the first and second haptic signal, detect a volitional user input corresponding to at least one option selected by the user and communicating the option selected by the user; and
vi. wherein the controller enables the user to control the multiplatform communication and control system to communicate without visual or audio inputs by providing a haptic based interface.

2. The system of claim 1, wherein the input signal includes at least one of a context input data, a user input data, and a third-party input data.

3. The system of claim 1, wherein the user input devices include one or more electromyography (EMG) assistive technology devices.

4. The system of claim 1, wherein the output signal includes at least one output signal prompt wherein the prompt is delivered by one or more output devices controlled by the controller.

5. The system of claim 1, wherein the output signal includes at least one control signal for an audible, a visual or a haptic device.

6. A method for providing multiplatform communication and control, comprising:
detecting, at least one input signal, via one or more switches in communication with the controller, wherein the input signal includes at least one of context input signal, a user input signal, and a third-party input signal;
determining, at the controller, one or more output signal for the input signal, wherein the output signal includes a first option and a second option;
assigning, at the controller, the first option to a first haptic signal and the second option to a second haptic signal;
providing sequentially, via a wearable user interface device in communication with the controller, a first haptic stimulation corresponding to the first haptic signal and a second haptic simulation corresponding to the second haptic signal to the user for choice selections, and
detecting, via the switches, a volitional user input corresponding to at least one option selected by the user and communicating the option selected by the user;
enabling the user to control the multiplatform communication and control system to communicate without visual or audio inputs by providing a haptic based interface.

7. The method of claim 6, wherein the user input devices include one or more electromyography (EMG) assistive technology devices.

8. The method of claim 6, wherein the input signal includes at least one of a context input data, a user input data, and a third-party input data.

9. The method of claim 6, wherein the output signal includes at least one output signal prompt, wherein the prompt is delivered by one or more output device controlled by the controller to deliver one or more of an audible prompt, visual prompt or tactile prompt.

10. A computer program product, comprising:
a computer readable storage device; and
program code on the computer readable storage device that when executed by a processor associated with an electronic device, the program code enables the electronic device to provide functionality to:
detect at least one input signal, wherein the input signal includes at least one of context input signal, a user input signal, and a third-party input signal;
determine one or more output signal for the input signal, wherein the output signal includes a first option and a second option;
assign the first option to a first haptic signal and the second option to a second haptic signal;
provide sequentially a first haptic simulation corresponding to the first haptic signal and a second haptic simulation corresponding to the second haptic signal to the user for choice selections, and
detect a volitional user input corresponding to at least one option selected by the user and communicating the option selected by the user;
enabling the user to control the multiplatform communication and control system to communicate without visual or audio inputs by providing a haptic based interface.

11. The computer program product of claim 10, wherein the input signal includes at least one input signal from an electromyography (EMG) sensor.

12. The computer program product of claim 10, wherein the output signal includes at least one control signal for an audible, a visual or a haptic device.
